(19) United States
(12) Patent Application Publication
(10) Pub. No.: US 2026/0200261 A1
(43) Pub. Date: Jul. 16, 2026

(54) Buddha Board

(71) Applicant: ERIC HAZRLTON THRALL, WEST VANCOUVER (CA)

(72) Inventor: ERIC HAZRLTON THRALL, WEST VANCOUVER (CA)

(21) Appl. No.: 19/446,462

(22) Filed: Jan. 12, 2026

Related U.S. Application Data
(60) Provisional application No. 63/744,029, filed on Jan. 10, 2025.

(51) Int. Cl. B43L 5/00; B43L 13/00

(52) U.S. Cl. CPC B43L 5/00; B43L 13/00

(57) ABSTRACT

A drawing board that comprises a board, a trim, and a water brush. The drawing board is intended to be used with paper, providing a stable surface for one to use the water brush on. The trim is perimetrically positioned around the board, which provides a mechanism that securely holds the paper in place while the drawing board is being used. A water brush is supplied, which contains a reservoir. The reservoir holds water, which when used the water is secreted out through the bristles of the brush on to the paper, producing an image.

### FIELD OF THE INVENTION

The present invention relates generally to art supplies. More specifically, the invention is a water painting surface.

### BACKGROUND OF THE INVENTION

Art can be a hobby, career, or relaxing activity for many. However, it can be a large task to cart a plethora of art supplies around. Additionally, to be near a water source may not always be possible or if one has a water source nearby, may not have a dish to hold the water while painting.

An object of the present invention is to provide a surface that one can reuse multiple times over and over again. The invention is a two part apparatus with a bush and easel board included.

### BRIEF DESCRIPTION OF THE DRAWINGS

FIG. 1 is perspective view of the invention.

FIG. 2 is front-left view of the present invention with the water brush.

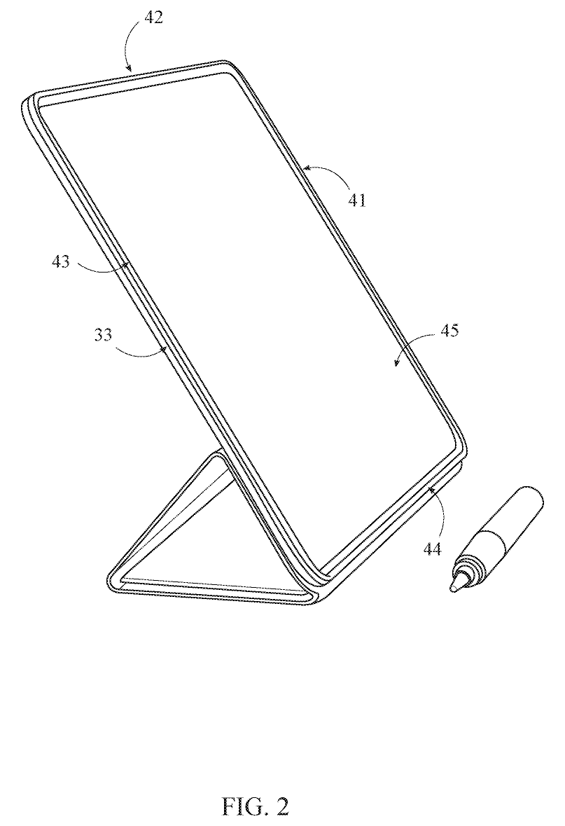

FIG. 3 is front elevation view of the water brush.

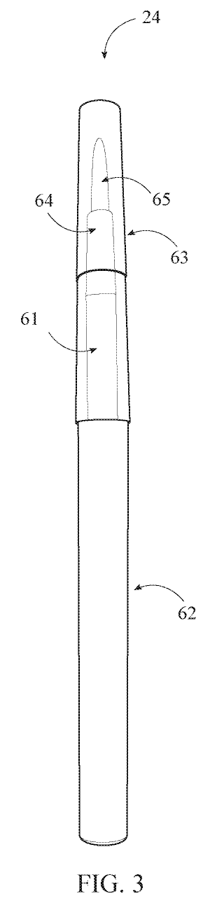

FIG. 4 is a rear-right elevation view of the present invention with the cover folded.

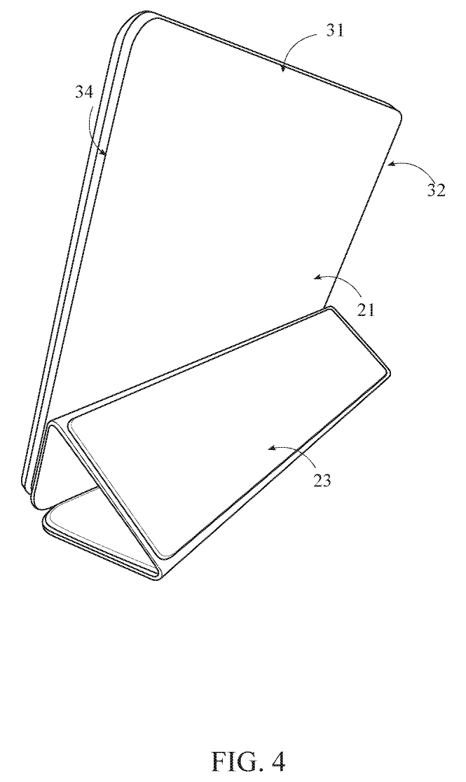

### DETAIL DESCRIPTIONS OF THE INVENTION

All illustrations of the drawings are for the purpose of describing selected versions of the present invention and are not intended to limit the scope of the present invention.

The present invention is a portable, foldable surface for painting on, known as a Buddha board. The board 10 comprises panel 21, a cover, and a water brush. The paint brush 24 is a refillable reservoir that houses water that the user needs to be able to paint on the board. The board further comprises a panel 21 and a trim 22. The panel 21 is rectangle shaped surface in which a sheet kanji paper is placed. The panel 21 comprises a first edge 31, a second edge 32, a third edge 33, and a fourth edge 34. The first edge 31 and third edge 33 are parallel to one another and similarly the second edge 32 and fourth edge 34 are parallel to one another. The first edge 31 and the third edge 33 are the same length and the second edge 32 and fourth edge 34 being the same length. The first edge 31 and third edge 33 are longer in length than the second edge 32 and fourth edge 34. The first edge 31 is positioned between the second edge 32 and fourth edge 34 and the third 33 edge is also positioned between the second edge 32 and fourth edge 34, opposite the first edge 31.

The trim 22 is perimetrically positioned around the panel 21. The trim 22 is what holds the sheet of paper in place while in use. The trim 22 is welded to the panel 21. The trim 22 comprises a first boundary 41, a second boundary 42, a third boundary 43 and a fourth boundary 44. Further, the trim 22 has a central aperture 45, which is necessary to allow the user to be able to gain access to the sheet of kanji paper that is being held in place. Just as with the panel 21, the first boundary 41 and third boundary 43 are parallel to one another while the second boundary 42 and fourth boundary 44 are parallel to one another. The first boundary 41 and the third boundary 43 are the same length and the second boundary 42 and fourth boundary 44 being the same length, which is required to that the trim 22 is the same size as the exterior border of the panel 21.

The first boundary 41 and third boundary 43 are longer in length than the second boundary 42 and fourth boundary 44 and the first boundary 41 is positioned between the second boundary 42 and fourth boundary 44 and the third boundary 43 being positioned between the fourth boundary 44 opposite the first boundary 41, giving the trim 22 its rectangular shape.

The cover 23 is hingedly connected to the panel 21. The cover 23 comprises a first side 51, a second side 52, a third side 53, and a fourth side 54. The cover 23 has two divots, a proximal divot 55 and a distal divot 56, that traverse the entire height of the cover, from the second side 52 of the cover 23 to the fourth side 54 of the cover 23. The proximal divot 55 is positioned adjacent to the first side 51 of the cover 23 while the distal divot 56 is positioned adjacent to the first side 51 of the cover 23.

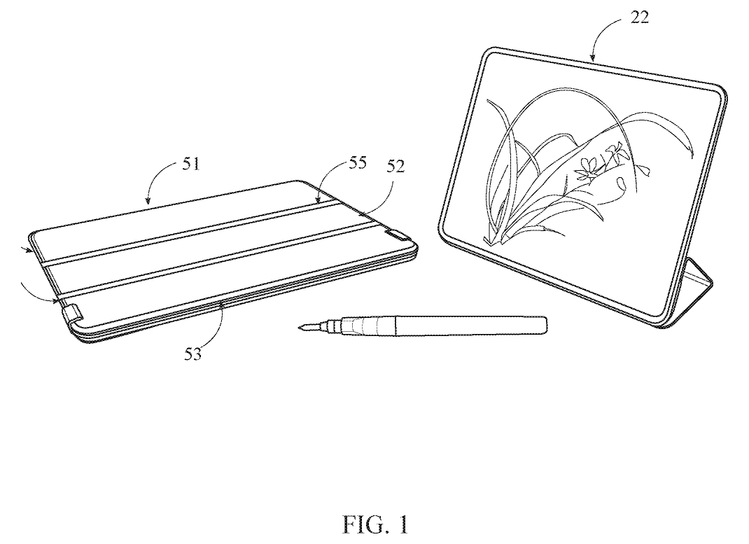

These divots allow the cover 23 to be tri-folded to form a triangle which serves as a stand to keep the invention upright when in use, as shown in FIG. 1. Because the cover 23 is hingedly connected, it allows it to be rotated about its axis to serve as a stand but when not being used as a stand, it covers the panel 21 that houses the kanji sheet. The first side 51 and third side 53 of the cover 23 are parallel to one another. The second side 52 and fourth side 54 of the cover 23 are parallel to one another. The first side 51 and the third side 53 of the cover 23 are the same length and the second side 52 and fourth side 54 are the same length. The first side 51 and third are longer in length than the second side 52 and fourth side 54. The first side 51 being positioned between the second side 52 and fourth side 54. The third side 53 is positioned between the fourth side 54 opposite the first side 51.

The water brush 24 comprises a housing 62, a reservoir 61 and a cap 63. The housing 62 is a cylindrical in shape and is perimetrically positioned on top of the base forming a hollow tube. The water is housed within the hollow space of the reservoir 61. At the end of the reservoir 61, opposite the base, is a tip 64. Extending from the tip 64 are a plurality of bristles 65.

The reservoir 61 being diametrically smaller than the housing 62, which is needed to fit the reservoir 61 into the housing 62. The reservoir 61 being positioned within the housing 62. The reservoir 61 is narrower than the cap 63. The cap 63 is slidably attached to the housing 62. When the invention is in use, these bristles 65 are dipped into water and then dragged across a sheet of kanji paper, which produces an image.

When in use, the plurality of bristles 65 are wettened by the water contained within the water brush 24. When the water makes contact with the kanji paper, it produces a black ink along the path that the water brush 24 has traveled, which brings a painting to life. However, as the paper dries, the image disappears when the paper is no longer wet.

Although the invention has been explained in relation to its preferred embodiment, it is to be understood that many other possible modifications and variations can be made without departing from the spirit and scope of the invention.

What is claimed is:

1. A drawing board comprising:
a board;
a water brush;
a cover;
the board further comprising a panel and a trim; and
the panel comprising a first edge, a second edge, a third edge and a fourth edge.

2. The drawing board as claimed in claim 1 comprising:
the first edge and third edge being parallel to one another;
the second and fourth edge being parallel to one another;
the first edge and the third edge being the same length; and
the second edge and fourth edge being the same length.

3. The drawing board as claimed in claim 1 comprising:
the first edge and third edge being longer in length than the second edge and fourth edge.
the first edge being positioned between the second and fourth edge; and
the third edge being positioned between the fourth edge opposite the first edge.

4. The drawing board as claimed in claim 1 comprising:
the trim comprising a first boundary, a second boundary, a third boundary and a fourth boundary;
the trim having a central aperture; and
the trim being perimetrically positioned around the panel.

5. The drawing board as claimed in claim 4 comprising:
the first boundary and third boundary being parallel to one another;
the second boundary and fourth boundary being parallel to one another;
the first boundary and the third boundary being the same length; and
the second boundary and fourth boundary being the same length.

6. The drawing board as in claim 4 comprising:
the first boundary and third boundary being longer in length than the second boundary and fourth boundary;
The first boundary being positioned between the second boundary and fourth boundary; and
The third boundary being positioned between the fourth boundary opposite the first boundary.

7. The drawing board as claimed in claim 1 comprising:
The cover being hingedly connected to the board; and
The cover comprising a first side, a second side, a third side, and a fourth side.

8. The drawing board as claimed in claim 1 comprising:
The cover having a first proximal divot a distal divot;
The distal divot and the proximal divot teach traverse from the second edge to the fourth edge of the cover;
The proximal divot being positioned adjacent to the first side; and
The distal divot being positioned adjacent to the third side.

9. The drawing board as claimed in claim 7 comprising:
the first side and third side being parallel to one another;
the second side and forth side being parallel to one another;
the first side and the third side being the same length; and
the second side and fourth side being the same length.

10. The drawing board as claimed in claim 7 comprising:
the first side and third side being longer in length than the second side and fourth side.
The first side being positioned between the second side and fourth side; and
The third side being positioned between the fourth side opposite the first side.

11. The drawing board as claimed in claim 1 comprising:
the water brush comprising a housing, a reservoir and a cap;
the reservoir being diametrically smaller than the housing;
the reservoir being positioned within the housing;
the reservoir being narrower than the cap; and
the cap being slidably attached to the housing;

12. The drawing board as in claim 11 comprising:
The reservoir having a tip at one end of the housing; and
A plurality of bristles extending out from the tip.

13. A drawing board comprising:
a board;
a water brush;
a cover;
the board further comprising a panel and a trim; and
the panel comprising a first edge, a second edge, a third edge and a fourth edge;
the first edge and third edge being parallel to one another;
the second and fourth edge being parallel to one another;
the first edge and the third edge being the same length; and
the second edge and fourth edge being the same length.

14. The drawing board as claimed in claim 13 comprising:
the first edge and third edge being longer in length than the second edge and fourth edge.
the first edge being positioned between the second and fourth edge;
the third edge being positioned between the fourth edge opposite the first edge;
the trim comprising a first boundary, a second boundary, a third boundary and a fourth boundary;
the trim having a central aperture; and
the trim being perimetrically positioned around the panel.

15. The drawing board as claimed in claim 14 comprising:
the first boundary and third boundary being parallel to one another;
the second boundary and fourth boundary being parallel to one another;
the first boundary and the third boundary being the same length;
the second boundary and fourth boundary being the same length;
the first boundary and third boundary being longer in length than the second boundary and fourth boundary.
the first boundary being positioned between the second boundary and fourth boundary; and
the third boundary being positioned between the fourth boundary opposite the first boundary.

16. A drawing board as in claim 13 comprising
the cover being hingedly connected to the board;
the cover comprising a first side, a second side, a third side, and a fourth side;
the cover having a first proximal divot a distal divot;
the distal divot and the proximal divot teach traverse from the first edge to the third edge of the cover;
the proximal divot being positioned adjacent to the second side; and
the distal divot being positioned adjacent to the fourth side.

17. A drawing board as in claim 16 comprising:
the first side and third side being parallel to one another;
the second side and forth side being parallel to one another;
the first side and the third side being the same length;
the second side and fourth side being the same length;
the first side and third edge being longer in length than the second side and fourth side.
the first side being positioned between the second side and fourth side; and
the third side being positioned between the fourth side opposite the first side.

18. The drawing board as claimed in claim 15 comprising:
the water brush comprising a housing, a reservoir and a cap;
the reservoir being diametrically smaller than the housing;
the reservoir being positioned within the housing;
the reservoir being narrower than the cap;
the cap being slidably attached to the housing;
the reservoir having a tip at one end of the housing; and
a plurality of bristles extending out from the tip.
